(19) United States
(12) Patent Application Publication
(10) Pub. No.: US 2008/0106658 A1
(43) Pub. Date: May 8, 2008

(54) Multi-domain liquid crystal display

(75) Inventors: Wen-Chun Wang, Tai Chung City (TW); Wan-Jen Tsai, Lung Ching Hsiang (TW); Min-Chang Yu, Tai Chung City (TW); Chian-Chang Lee, Tai Chung City (TW)

Correspondence Address: BIRCH STEWART KOLASCH & BIRCH, PO BOX 747, FALLS CHURCH, VA, 22040-0747, US

(73) Assignee: Wintek Corporation

(21) Appl. No.: 11/979,040

(22) Filed: Oct. 30, 2007

(30) Foreign Application Priority Data
Nov. 3, 2006 (TW) 095140653

(51) Int. Cl. G02F 1/133

(52) U.S. Cl. 349/37

(57) ABSTRACT

A multi-domain liquid crystal display includes a plurality of picture elements arranged in an array of rows and columns and controlled by a line inversion drive scheme. Each picture element has a pixel electrode and at least one control electrode insulated from each other. All the control electrodes in the same row or the same column of picture elements are connected to the same signal source to provide a voltage difference between the control electrodes and the pixel electrodes in the same row or the same column of picture elements to produce fringe fields.

### BACKGROUND OF THE INVENTION

(a) Field of the Invention

The invention relates to a multi-domain liquid crystal display, and, more particularly, to a multi-domain liquid crystal display where fringe fields are produced to control the orientation of liquid crystal molecules.

(b) Description of the Related Art

Typically, the display contrast ratio and response time offered by a vertically-aligned (VA) mode liquid crystal display, which uses negative liquid crystal materials and vertical alignment films, are better than a twisted-nematic (TN) mode LCD, since liquid crystal molecules are aligned in a vertical direction when no voltage is applied. Also, it is known the viewing angle performance of a VA mode LCD is improved by setting the orientation of liquid crystal molecules inside each picture element to a plurality of mutually different directions; that is, forming multiple distinct domains in the liquid crystal display.

FIG. 1A shows a schematic diagram illustrating a conventional design of a multi-domain vertically aligned liquid crystal display (MVA LCD). Referring to FIG. 1A, a top substrate 102 and a bottom substrate 104 are both provided with protrusions 106 having different inclined surfaces and covered by vertical alignment films 108. Hence, the liquid crystal molecules 112 near the inclined surfaces orientate vertically to the inclined surfaces to have different degrees of pre-tilt angles. In case the pre-tilt liquid crystal molecules exist, surrounding liquid crystal molecules 112 are tilted in the directions of the pre-tilt liquid crystal molecules 112 when a voltage is applied. Thus, multiple domains each having individual orientation direction of liquid crystal molecules 112 are formed. Besides, the domain-regulating structure for providing inclined surfaces includes, but is not limited to, the protrusions 106, and other structure such as a via structure 114 shown in FIG. 1B may also be used.

However, when one compares the optical path of light I1 and that of light I2 shown both in FIGS. 1A and 1B, it can be clearly found the tilted liquid crystal molecules through which the light I2 passes under a field-off state may result in a non-zero phase difference (Δ nd≠0) to cause light leakage. Accordingly, additional compensation films must be provided to eliminate the light leakage.

FIG. 2 shows a schematic diagram illustrating another conventional design of an MVA LCD. Referring to FIG. 2, the transparent electrode 204 on the substrate 202 is provided with slits 206. Because of the fringe fields produced at edges of transparent electrode 204 and at each slit 206, the liquid crystal molecules 208 are tilted toward the center of each slit 206 to result in a multi-domain liquid crystal cell.

However, the strength of the fringe fields generated by the formation of the slits 206 is often insufficient, particularly when the widths and the intervals of the slits 206 are not optimized. Besides, the fringe fields produced as a result of the slits 206 may exert an opposite rotational force on the LC molecules 208 proximate to the edges of each slit to rotate them in an opposite rotational sense from the rotation of the pre-tilt angle relative to the transparent electrode 204, thus creating a disclination region 210 which often appears beyond the slits 206 or between two adjacent slits 206 to result in a reduced light transmittance.

Further, though the protrusion 106, via structure 114, or slit 206 may be provided to create multiple domains, the distribution of these structures in a picture element may reduce the active display area and thus decrease the pixel aperture ratio.

In order to solve the problems mentioned above, a bias-bending technique is proposed where fringe fields are produced to regulate the orientation of liquid crystal molecules. More specifically, referring to FIG. 3, a control electrode 216 is formed on a transparent substrate 212 and is positioned under a pixel electrode 218, and the control electrode 216 and the pixel electrode 218 are insulated from each other by a dielectric layer 222. A common electrode 224 is provided on a transparent substrate 214 opposite to the transparent substrate 212. An opening 226 is formed on the pixel electrode 218 at a position overlapping the control electrode 216 to introduce fringe fields produced between the control electrode 216 and the pixel electrode 218 due to their voltage differences, causing the orientation of liquid crystal molecules divided into a plurality of mutually different directions. In other words, each picture element is caused to have multiple distinct domains.

Assume Vct, Vp, and Vcom respectively denotes the voltage on the control electrode 216, the pixel electrode 218, and the common electrode 224, the following criteria must be met to reduce the number of disclination lines for the use of the above bias-bending technique under a polarity inversion drive scheme:
1. If the voltage on the pixel electrode is larger than that on the common electrode, then Vct>Vp>Vcom; and
2. If the voltage on the pixel electrode is smaller than that on the common electrode, then Vct<Vp<Vcom.

Thus, as shown in FIG. 4, US patent publication No. 20050083279 discloses a dot inversion drive method where each pixel 300 is provided with two transistors T1 and T2 that are precisely turned on and off at select time points to perform a voltage control so as to satisfy the above criteria.

However, in the dot inversion drive method of the conventional design, a constant common voltage Vcom is needed to result in high power dissipation. More specifically, the common voltage Vcom, such as 0 volt, and two opposing voltages, such as +2 volt and −2 volt, are used to form a positive polarity and a negative polarity for the same gray level, so that it is possible to output a voltage two times greater than that of a line inversion drive method where a time-variable common voltage is used. Further, a comparatively higher layout area is required for the circuit architecture of the dot inversion drive scheme, and, in the conventional method, the two transistors T1 and T2 provided in one pixel 300 inevitably cause a higher fabrication cost and a lower pixel aperture ratio.

### BRIEF SUMMARY OF THE INVENTION

Hence, an object of the invention is to provide a multi-domain liquid crystal display capable of solving the problems of conventional designs.

According to the invention, a multi-domain liquid crystal display includes a plurality of picture elements arranged in an array of rows and columns and controlled by a line inversion drive scheme. Each picture element has a pixel electrode and at least one control electrode insulated from each other. All the control electrodes in the same row or the same column of picture elements are connected to the same signal source to provide a voltage difference between the control electrodes and the pixel electrodes in the same row or the same column of picture elements to produce fringe fields.

Through the design of the invention, a voltage control used to reduce disclination region under a polarity inversion drive scheme can be easily performed by providing only one TFT in each picture element, because a line inversion (row inversion or column inversion) drive scheme is used to aid in the formation of multiple domains and all the control electrodes in the same row or the same column of picture elements are connected to the same signal source. Thus, there is no need to provide two TFTs in one picture element as in the conventional design to reduce the fabrication cost. Further, under a line inversion drive scheme, a time-variable common voltage instead of a constant common voltage is used, so there is no need to provide two opposing voltages to form a positive polarity and a negative polarity for the same gray level. Accordingly, the power dissipation and circuit layout areas can both be reduced.

These and other embodiments, aspects, advantages, and features of the present invention will be set forth in part in the description which follows, and in part will become apparent to those skilled in the art by reference to the following description of the invention and referenced drawings or by practice of the invention. The aspects, advantages, and features of the invention are realized and attained by means of the instrumentalities, procedures, and combinations particularly pointed out in the appended claims.

### BRIEF DESCRIPTION OF THE DRAWINGS

FIG. 1A shows a schematic diagram illustrating a conventional design of a multi-domain vertically aligned liquid crystal display.

FIG. 1B shows a schematic diagram illustrating another conventional design of a multi-domain vertically aligned liquid crystal display.

FIG. 2 shows a schematic diagram illustrating another conventional design of a multi-domain vertically aligned liquid crystal display.

FIG. 3 shows a schematic diagram illustrating another conventional design of a multi-domain vertically aligned liquid crystal display.

FIG. 4 shows an equivalent circuit diagram of FIG. 3.

FIG. 5 shows a schematic diagram illustrating a drive circuitry for a polarity inversion control in a liquid crystal display.

FIGS. 6A and 6B show schematic diagrams respectively illustrating a column inversion and a row inversion polarity patterns of a liquid crystal display under a polarity inversion drive scheme.

FIG. 7 shows a top view observed from the normal direction of an array substrate according to an embodiment of the invention.

FIGS. 8A and 8B show equivalent circuit diagrams of FIG. 7.

FIG. 9 shows a diagram illustrating the waveforms of voltage signals supplied to the pixel electrode, the common electrode, and the gate line.

FIGS. 10A and 10B show diagrams illustrating the sectional structure of a picture element according to an embodiment of the invention.

FIG. 11 shows a plan view illustrating another embodiment of the invention.

FIG. 12A shows a diagram illustrating the sectional structure of a picture element according to another embodiment of the invention.

FIG. 12B shows a diagram illustrating the sectional structure of a picture element according to another embodiment of the invention.

FIG. 13 shows a diagram illustrating the sectional structure of a picture element according to another embodiment of the invention.

FIG. 14 shows a plan view illustrating another embodiment of the invention.

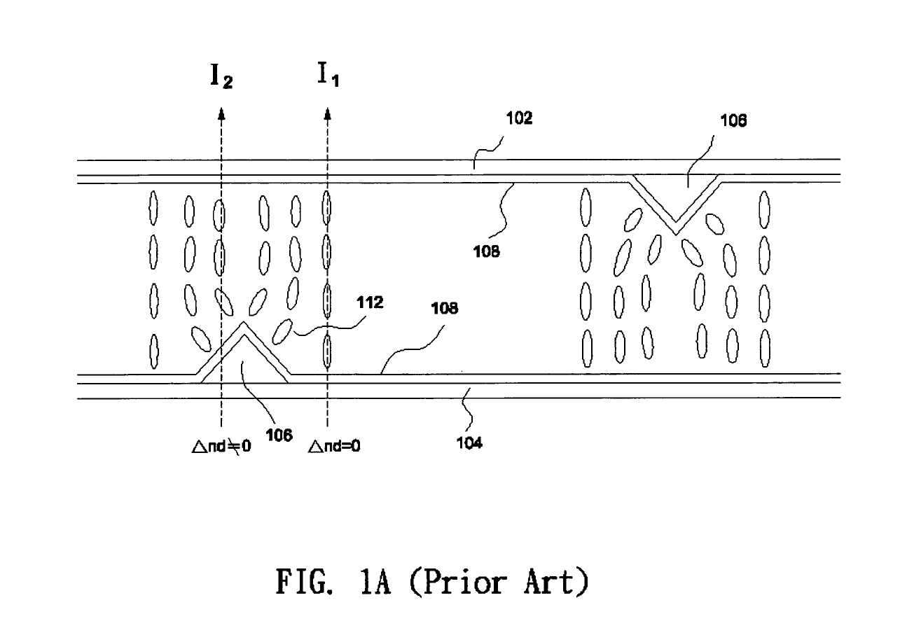

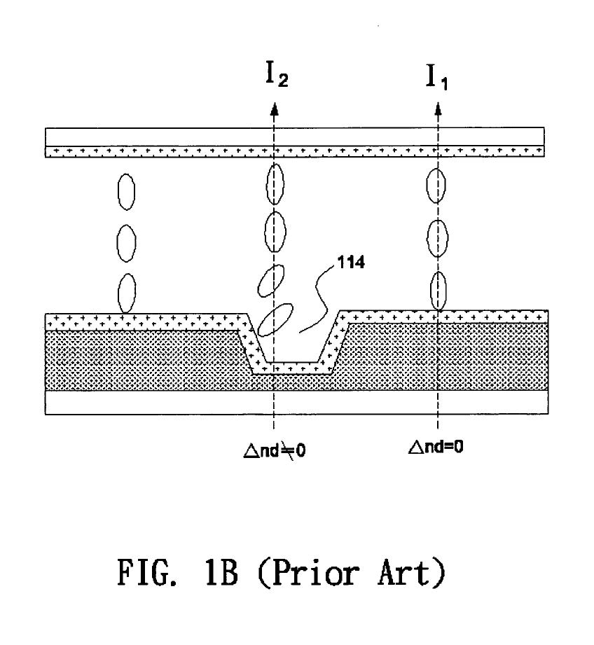

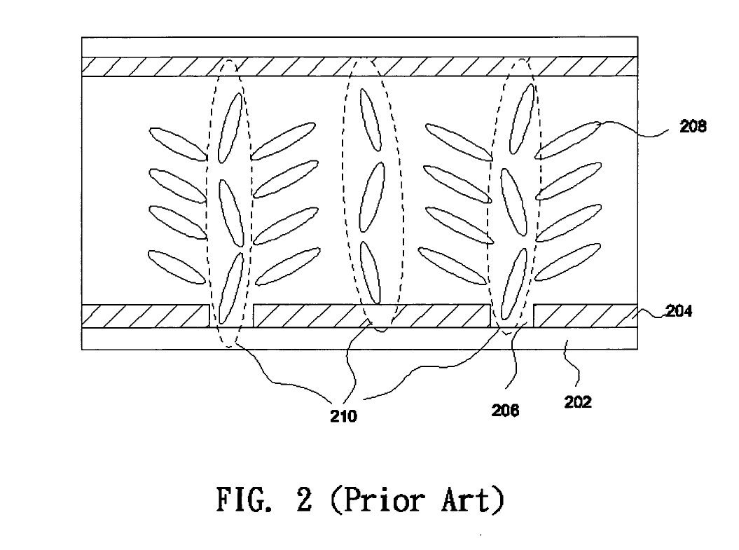

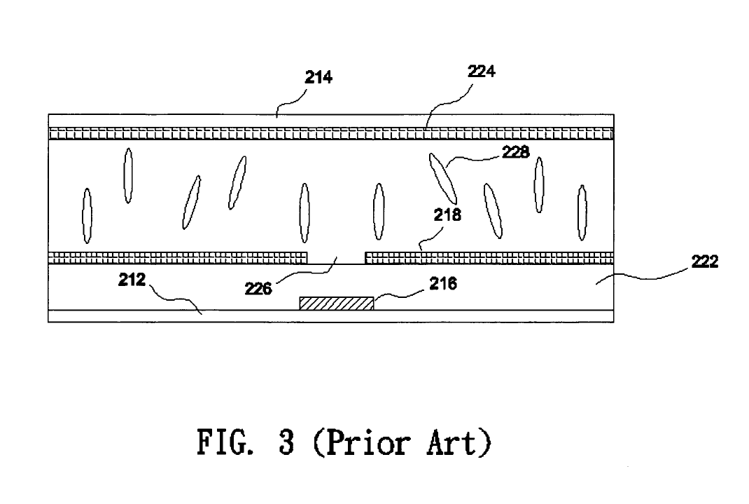

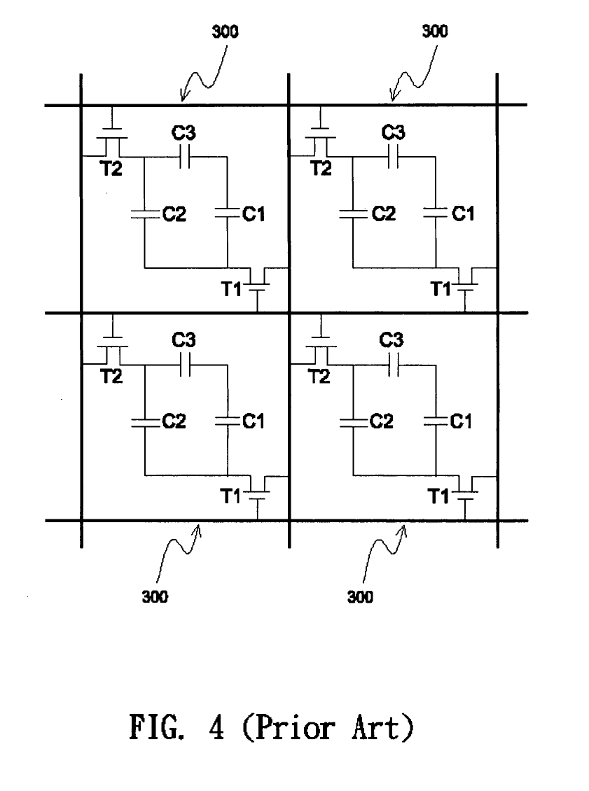

### DETAILED DESCRIPTION OF THE INVENTION

FIG. 5 shows a schematic diagram illustrating a drive circuitry 50 for a polarity inversion control in a liquid crystal display. Referring to FIG. 5, a display control circuit 52 generates display clock signals CK, horizontal synchronizing signals HSY, vertical synchronizing signals VSY and digital image data Da, which are supplied to a column electrode driving circuit 54 and a row electrode driving circuit 56. Also, the drive circuitry 50 includes a polarity switch circuit 52a that inverts polarities of data signals (i.e., positive-negative polarity of the electric voltage to be supplied to the liquid crystal panel 60) through a polarity control signals φ according to the horizontal synchronizing signals HSY and the vertical synchronizing signals VSY. Further, a common electrode drive circuit 58 provides the common electrode of the liquid crystal panel 60 with a common voltage Vcom.

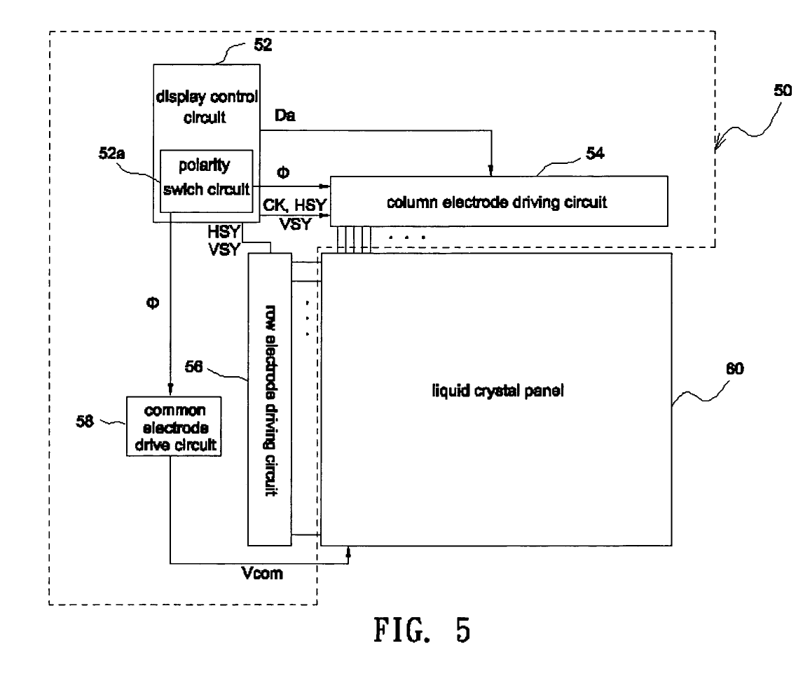

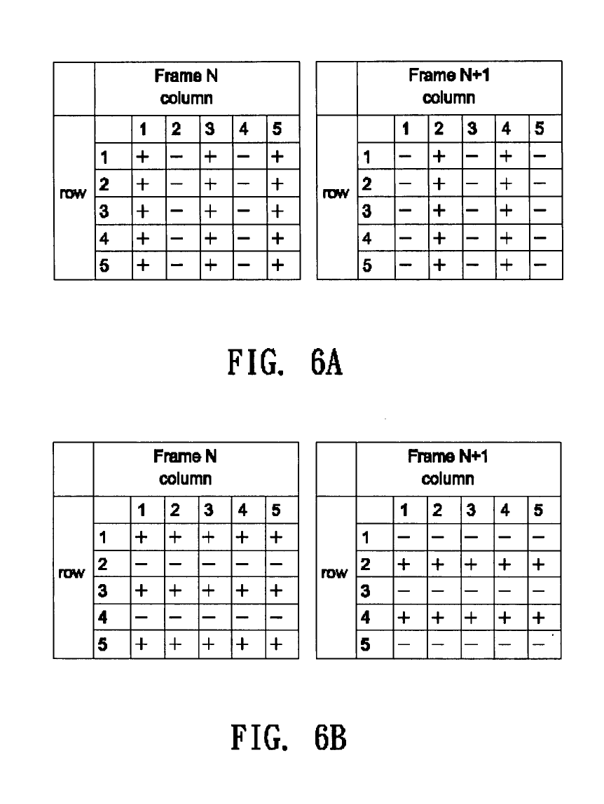

FIGS. 6A and 6B show schematic diagrams respectively illustrating a column inversion and a row inversion polarity patterns of a liquid crystal display under a polarity inversion drive scheme. It can be seen positive-polarity picture elements and negative-polarity picture elements alternate with each other in the horizontal direction or in the vertical direction under the same frame of a line inversion drive scheme. Hence, according to the invention, a line inversion drive scheme (the column inversion shown in FIG. 6A or the row inversion shown in FIG. 6B) can provide a base for forming multiple liquid crystal domains.

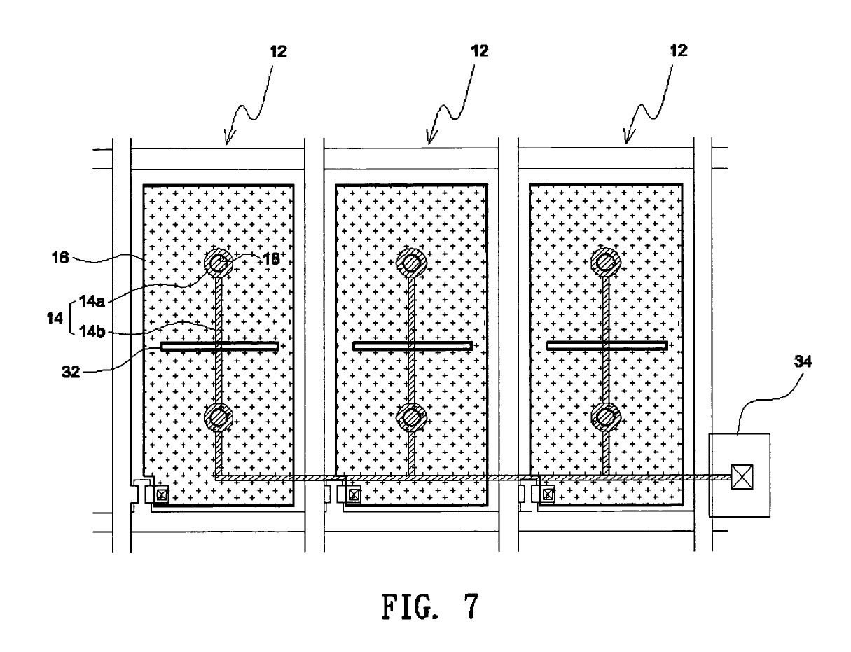

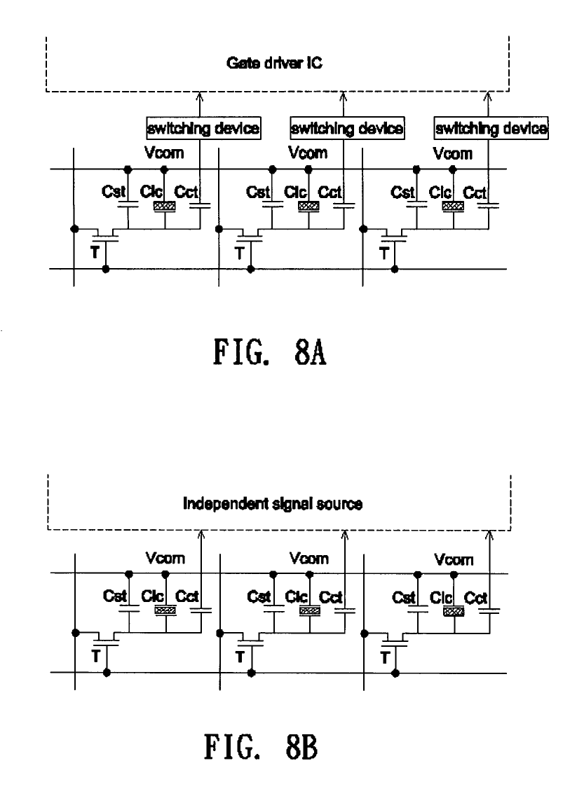

FIG. 7 shows a top view observed from the normal direction of an array substrate according to an embodiment of the invention, and FIGS. 8A and 8B show equivalent circuit diagrams of FIG. 7. Referring to FIG. 7, each picture element 12 is divided into two sub picture elements by a slit 32, and each sub picture element is provided with at least one control electrode 14 (indicated by hatched lines). According to this embodiment, each control electrode 14 includes a field-induced part 14a and a connection part 14b. The field-induced part 14a is exemplified as circular-shaped, and a circular opening 18 is provided on the pixel electrode 16 at a position overlapping the field-induced part 14a to introduce the fringe fields produced between the pixel electrode 16 and the field-induced part 14a due to their voltage differences. Preferably, the area of the circular field-induced part 14a is larger than that of the circular opening 18 to provide sufficient field strength.

As shown in FIG. 7, all the control electrodes 14 in the same row of picture elements are connected to the same signal source 34, and the signal source 34 is provided in the non-active display area outside the picture element regions thus not decreasing the pixel aperture ratio. As for an active matrix type liquid crystal display, an on-state voltage VGH supplied to gate lines is used to turn on a thin film transistor (TFT), and an off-state voltage VGL supplied to gate lines is used to turn off the TFT. Hence, as shown in FIG. 8A, in one embodiment the signal source 34 is a gate driver IC, where all the control electrodes 14 in the same row of picture elements are connected to the IC pins that supply the on-state voltage VGH and the off-state voltage VGL. Also, a switching device may be additionally provided and connected between the control electrode and the IC pin to further adjust the voltage level. In an alternate embodiment shown in FIG. 8B, all the control electrodes 14 in the same row of picture elements are connected to an independent voltage source irrelevant to the drive scheme of a TFT. For example, an IC may provide additional pins to supply independent voltage signals to the control electrodes 14.

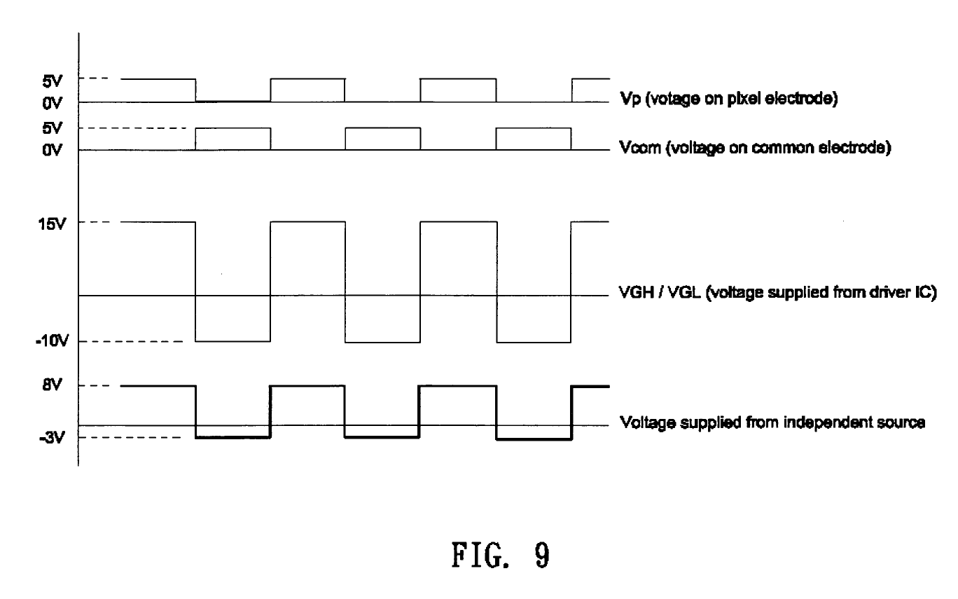

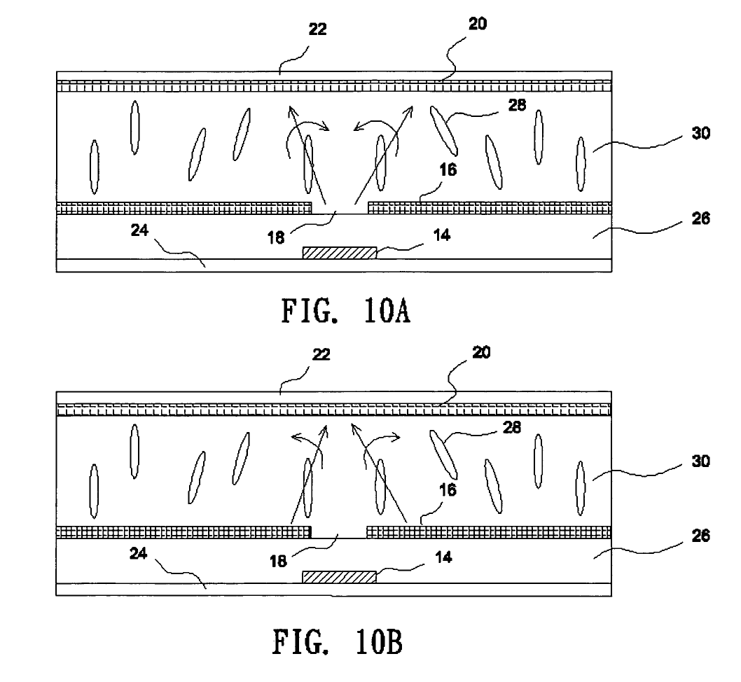

FIG. 9 shows a diagram illustrating the waveforms of voltage signals supplied to the pixel electrode, the common electrode, and the gate line. FIGS. 10A and 10B show diagrams illustrating the sectional structure of a picture element according to an embodiment of the invention. The operation principle of the invention is described below with reference to these diagrams.

First, as shown in FIG. 10A, a common electrode 20 is provided on one side of a substrate 22, and a plurality of control electrodes 14 are formed on one side of a substrate 24 facing the substrate 22 and are covered by a dielectric layer 26. A plurality of pixel electrodes 16 are formed on the dielectric layer 26, and the common electrode 20 and the pixel electrode 16 are insulated from each other to form a liquid crystal capacitor CIc. The control electrodes 14 may be formed from a Metal 1 layer or a Metal 2 layer during typical array substrate fabrication processes, and an additive of chiral dopant may be added to the liquid crystal layer 30 to adjust the twist pitch to a desired value so as to reduce the area of a disclination region. When a voltage is applied across the common electrode 20 and the pixel electrode 16, a vertical electric field is produced to have the orientation of liquid crystal molecules having negative dielectric anisotropy be substantially parallel to the substrate 24. According to the invention, each pixel electrode 16 is provided with at least one opening 18 at a position overlapping the control electrode 14 to introduce fringe fields produced between the biased control electrode 14 and the pixel electrode 16, so that the liquid crystal molecules are aligned in symmetrical directions to create multiple distinct domains.

Referring to FIG. 9, in this embodiment, the multi-domain liquid crystal display is controlled by a row inversion drive scheme. Hence, the voltage Vcom on the common electrode 16 alternates between 0V and 5V, while the voltage Vp on the pixel electrodes 16 in the same row of picture elements correspondingly alternates between 5V and 0V to result in a reversed polarity between two adjacent gate lines, and thus each liquid crystal cell can be electrically addressed through the voltage difference between the common electrode 20 and the pixel electrode 16. An on-state voltage VGH of 15 V supplied from a gate driver IC is fed to the gate lines to turn on a TFT, while an off-state voltage VGL of −10 V supplied from the gate driver IC is fed to the gate lines to turn off the TFT. According to this embodiment, since all the control electrodes 14 in the same row of picture elements are connected to the same signal source such as the gate driver IC that supplies the on-state voltage VGH and off-state voltage VGL, the voltage Vct on the control electrodes 14 in the same row of picture elements alternates between 15V and −10V. Hence, as shown in FIG. 10A, when Vcom=0V and Vp=5V, the voltage Vct on the control electrodes 14 in the same row of picture elements is set as 15V, so that the liquid crystal molecules 28 are tilted inwards to have their long axis directions perpendicular to the direction of oblique electric field. On the other hand, when Vcom=5V and Vp=0V, the voltage Vct on the control electrodes 14 in the same row of picture elements is set as −10V to inwardly tilt the liquid crystal molecules 28. More specifically, according to the invention, in the same row of picture elements the voltage Vct on the control electrodes 14 becomes larger than the voltage Vp on the pixel electrodes 16 when the voltage Vp on the pixel electrodes is larger than the voltage Vcom on the common electrode 20. Besides, in the same row of picture elements the voltage Vct on the control electrodes 14 becomes smaller than the voltage Vp on the pixel electrodes 16 when the voltage Vp on the pixel electrodes 16 is smaller than the voltage Vcom on the common electrode 20. The number of disclination lines is decreased as the above conditions are satisfied; otherwise, the liquid crystal molecules are tilted outwardly as shown in FIG. 10B to increase the number of disclination lines.

Through the design of the invention, the above conditions for voltage control can be satisfied by providing only one TFT in each picture element, because a line inversion (row inversion or column inversion) drive scheme is used to aid in the formation of multiple domains and all the control electrodes 14 in the same row or the same column of picture elements are connected to the same signal source. Thus, there is no need to provide two TFTs in one picture element as in the conventional design to reduce the fabrication cost. Further, under a line inversion drive scheme, a time-variable common voltage instead of a constant common voltage is used, so there is no need to provide two opposing voltages to form a positive polarity and a negative polarity for the same gray level. Accordingly, the power dissipation and circuit layout areas can both be reduced.

Also, the signal source 34 that is connected with all the control electrodes 14 in the same row of picture elements may be an independent voltage source irrelevant to the drive scheme of a TFT. As illustrated in the lowest waveform shown in FIG. 9, the independent voltage source may supply a positive voltage of 8V to the control electrode 14 as the voltage on the pixel electrode Vp=5V and the voltage on the common electrode Vcom=0V (Vct>Vp>Vcom). On the other hand, it may supply a negative voltage of −3V to the control electrode 14 as the voltage on the pixel electrode Vp=0V and the voltage on the common electrode Vcom=5V (Vct<Vp<Vcom). The use of an independent voltage source may reduce the voltage difference between a positive and a negative frames to decrease power dissipation and may perform an independent control of the orientation of liquid crystal molecules without the influence of the on/off state of each TFT.

Though the above embodiment is implemented under a row inversion drive scheme, other polarity inversion technique may also be used such as a column inversion drive scheme, as long as all the control electrodes in the same column of picture elements are connected to the same signal source.

Referring back to FIG. 7 again, the slit 32 formed on each pixel electrode 16 divides the pixel electrode 16 into two sections. In other words, each picture element 12 is divided into two sub picture elements by the slit 32, and each sub picture element is provided with a field-induced part 14a to function as an independent unit for producing fringe fields. Except for the biased control electrode 14, the slit 32 may also induce fringe fields to tilt liquid crystal molecules. Though in the above embodiment each picture element 12 is divided into two sub picture elements, this division is not limited. Since the response time of liquid crystal molecules is reduced as the number of sub picture elements is increased, the manner of division can be arbitrarily selected according to the actual demand. Certainly, the multiple liquid crystal domains can be formed even no slits 32 are provided on the pixel electrodes 16.

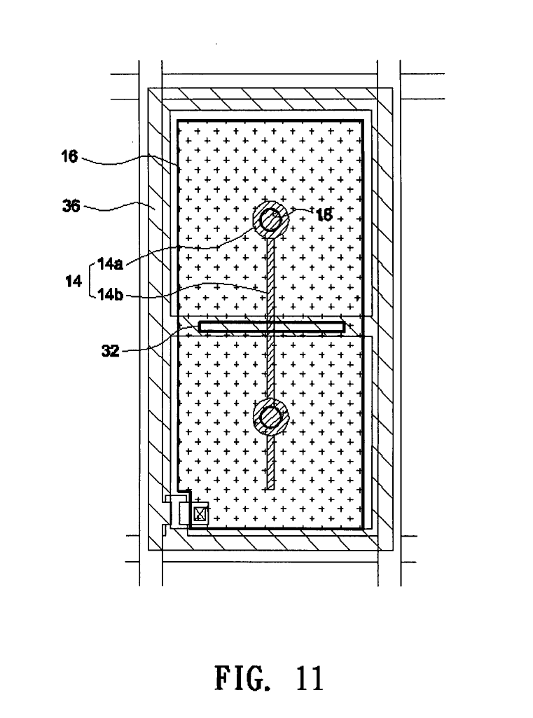

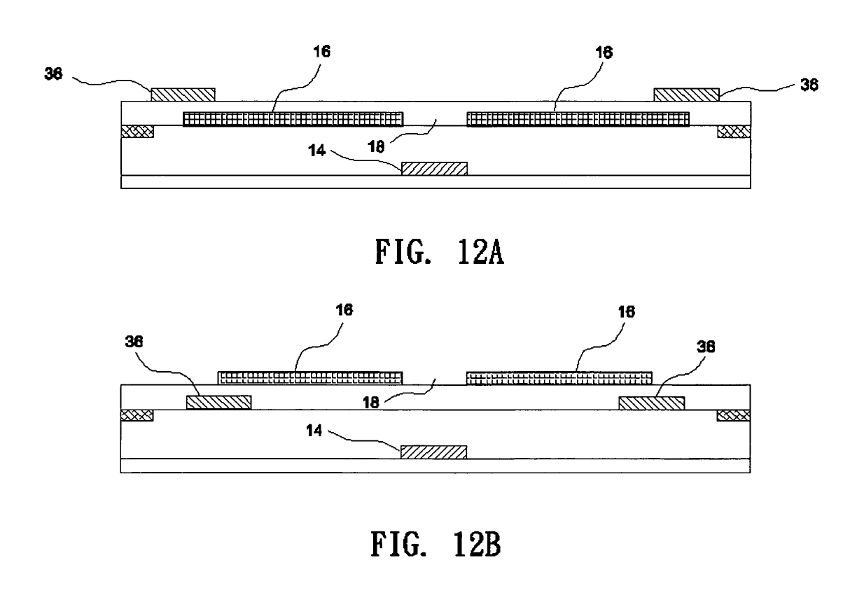

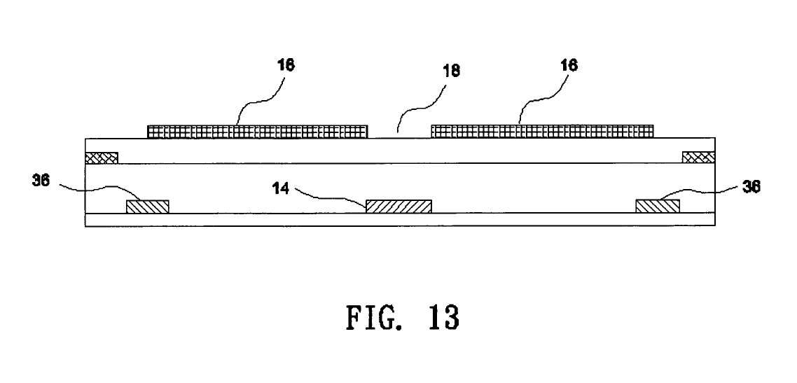

FIG. 11 shows a plan view illustrating another embodiment of the invention. Referring to FIG. 11, an auxiliary electrode 36 is additionally provided to at least partially surround the pixel electrode 16. The auxiliary electrode 36 is connected to a signal source to which the common electrode 20 is connected, so that the auxiliary electrode 36 is supplied with a common voltage Vcom and thus has a voltage difference in relation to the voltage Vp on the pixel electrode 16 to produce fringe fields. The auxiliary electrode 36 may cooperate with the control electrode 14 to further enhance the field strength to tilt liquid crystal molecules. The auxiliary electrode 36 may be formed from a Metal 3 layer and positioned over the pixel electrode 16 (shown in FIG. 12A) or under the pixel electrode 16 (shown in FIG. 12B). Alternatively, the auxiliary electrode 36 and the control electrode 14 may be both formed from a Metal 1 layer to simplify fabrication processes, as shown in FIG. 13.

Further, the relative position between the auxiliary electrode 36 and the pixel electrode 16 is not limited as long as sufficient field strength is maintained. For example, the auxiliary electrode 36 may overlap the pixel electrode 16 as shown in FIG. 12A and FIG. 12B.

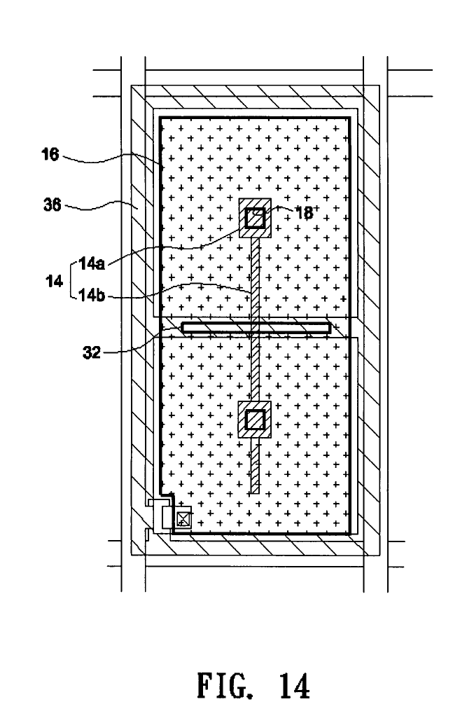

Moreover, the field-induced part 14a of the control electrode 14 and the opening 18 provided on the pixel electrode 16 is not limited to a particular geometric shape. For example, a circular shape shown in FIG. 7 or a polygonal shape such as a rectangular shape shown in FIG. 14 are suitable for use in connection with the present invention.

While the invention has been described by way of examples and in terms of the preferred embodiments, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation so as to encompass all such modifications and similar arrangements.

What is claimed is:

1. A multi-domain liquid crystal display, comprising:
a plurality of picture elements arranged in an array of rows and columns and controlled by a line inversion drive scheme, each of which has a pixel electrode and at least one control electrode insulated from each other, wherein all the control electrodes in the same row or the same column of picture elements are connected to the same signal source to provide a voltage difference between the control electrodes and the pixel electrodes in the same row or the same column of picture elements to produce fringe fields.

2. The multi-domain liquid crystal display as claimed in claim 1, wherein the signal source supplies a voltage signal to the control electrodes in the same row or the same column of picture elements, and the polarity of the voltage signal varies according to the polarity of the pixel electrodes in the same row or the same column of picture elements.

3. The multi-domain liquid crystal display as claimed in claim 1, wherein each picture element comprises a common electrode, the voltage on the control electrodes is set as larger than the voltage on the pixel electrodes in the same row or the same column of picture elements when the voltage on the pixel electrodes is larger than the voltage on the common electrode, and the voltage on the control electrodes is set as smaller than the voltage on the pixel electrodes in the same row or the same column of picture elements when the voltage on the pixel electrode is smaller than the voltage on the common electrode.

4. The multi-domain liquid crystal display as claimed in claim 1, wherein the signal source is a gate driver IC.

5. The multi-domain liquid crystal display as claimed in claim 1, further comprising a plurality of switching devices each connected between the control electrode and the signal source.

6. The multi-domain liquid crystal display as claimed in claim 1, wherein the signal source is an independent voltage source irrelevant to the drive scheme of a thin film transistor.

7. The multi-domain liquid crystal display as claimed in claim 1, wherein the signal source is provided in the non-active display area of the multi-domain liquid crystal display.

8. The multi-domain liquid crystal display as claimed in claim 1, wherein each control electrode includes a field-induced part and a connection part, and each pixel electrode is provided with at least one opening at a position overlapping the field-induced part.

9. The multi-domain liquid crystal display as claimed in claim 8, wherein the field-induced part of the control electrode and the opening have a circular shape or a polygonal shape, and the area of the field-induced part is larger than that of the opening.

10. The multi-domain liquid crystal display as claimed in claim 1, wherein each picture element is provided with at least one slit that divides each picture element into a plurality of sub picture elements.

11. The multi-domain liquid crystal display as claimed in claim 1, wherein each picture element further comprises an auxiliary electrode that at least partially surrounds the pixel electrode and is connected to a signal source that is different to the signal source to which the control electrode is connected.

12. A multi-domain liquid crystal display, comprising:
a first and a second substrates facing to each other;
a liquid crystal layer interposed between the first and the second substrates;
a common electrode provided on one side of the first substrate facing the second substrate;
a plurality of control electrodes formed on one side of the second substrate facing the first substrate;
a dielectric layer formed on the second substrate and covering the control electrodes; and
a plurality of pixel electrodes arranged in a form of an array of rows and columns on the dielectric layer, wherein two immediately adjacent rows of pixel electrodes have polarities opposite to each other, or two immediately adjacent columns of pixel electrodes have polarities opposite to each other under the same frame of an inversion drive scheme;
wherein all the control electrodes positioned overlapping the same row or the same column of pixel electrodes are connected to the same signal source that supplies a voltage signal whose polarity varies according to the polarity of the pixel electrodes in the same row or the same column.

13. The multi-domain liquid crystal display as claimed in claim 12, wherein the voltage on the control electrodes is set as larger than the voltage on the pixel electrodes in the same row or the same column when the voltage on the pixel electrodes is larger than the voltage on the common electrode, and the voltage on the control electrodes is set as smaller than the voltage on the pixel electrodes in the same row or the same column when the voltage on the pixel electrode is smaller than the voltage on the common electrode.

14. The multi-domain liquid crystal display as claimed in claim 12, wherein the signal source is a gate driver IC.

15. The multi-domain liquid crystal display as claimed in claim 12, further comprising a plurality of switching devices each connected between the control electrode and the signal source.

16. The multi-domain liquid crystal display as claimed in claim 12, wherein the signal source is an independent voltage source irrelevant to the drive scheme of a thin film transistor.

17. The multi-domain liquid crystal display as claimed in claim 12, wherein the signal source is provided in the non-active display area of the multi-domain liquid crystal display.

18. The multi-domain liquid crystal display as claimed in claim 12, wherein the control electrodes are formed from a Metal 1 layer or a Metal 2 layer.

19. The multi-domain liquid crystal display as claimed in claim 12, further comprising a plurality of auxiliary electrodes connected a signal source to which the common electrode is connected, and each auxiliary electrode at least partially surrounding the pixel electrode.

20. The multi-domain liquid crystal display as claimed in claim 12, wherein each pixel electrode is provided with at least one slit that divides each pixel electrode into a plurality of sections.
